(19) United States
(12) Patent Application Publication
(10) Pub. No.: US 2009/0187443 A1
(43) Pub. Date: Jul. 23, 2009

(54) VISUAL METAPHOR FOR ELAPSED TIME SPENT

(75) Inventor: Matt E. Hart, Lunenburg, MA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/018,671

(22) Filed: Jan. 23, 2008

(51) Int. Cl. G06Q 10/00

(52) U.S. Cl. 705/7

(57) ABSTRACT

An embodiment provides a system that visually indicates time spent on applications. During operation, the system can measure time spent on applications to obtain time spent data. The user can provide rules which specify when to start and when stop measuring time for an application. Next, the system can generate visual indicators based on the time spent data. A visual indicator can indicate an amount of time spent on an application by conveying the information in a non-textual manner. The system can then display the visual indicator to the user. The time spent data can be used to generate bills for clients by associating time spent records with client matters.

### BACKGROUND

### Related Art

The World Wide Web (WWW) has permeated almost all aspects of our lives—from buying cameras to buying real estate, and from reading a newspaper to watching a movie. In the course of a single day, an individual can easily use tens of computer-based applications for performing various tasks for personal or business reasons. For example, an individual can pay bills using a financial software, read newspapers on the web, prepare tax returns using a tax preparation software, and send and receive emails using a wireless handheld device.

In spite of these technological advances, there still remains a strong need for innovative applications and user interfaces that can increase user productivity. Specifically, information overload and non-intuitive user interfaces often limit the productivity gains that can be achieved from technological innovations. Hence, the industry is continually looking for ways to develop applications and user interfaces that can increase user productivity.

### SUMMARY

One embodiment of the present invention provides a system that visually indicates time spent on applications. During operation, the system can measure time spent on applications to obtain time spent data. Next, the system can generate visual indicators based on the time spent data. A visual indicator can indicate an amount of time spent on an application and can convey the information in a non-textual manner. The system can then display the visual indicators to the user.

In a variation on this embodiment, an application includes an e-mail application, a word processing application, a spreadsheet application, a tax preparation application, a phone application, a web-browser, and/or a website which provides a web-based application.

In a variation on this embodiment, the visual indicator's size and/or location can be used to convey the amount of time spent. Alternatively, the visual indicator's color can be used to convey the amount of time spent. In yet another variation, the visual indicator can include a snapshot of the application to enable the user to quickly identify the application associated with the visual indicator.

In a variation on this embodiment, the system receives a request from a user to stop measuring time spent on an application. Next, the system stops measuring time for that application, but continues to measure time for other applications.

In a variation on this embodiment, the system may reconcile time spent records which indicate that the user spent time on multiple applications at the same time. For example, the time spent data may indicate that a first amount of time was spent on a first application and at the same time a second amount of time was spent on a second application. The system may reconcile these time spent records by determining a difference between the first amount of time and the second amount of time, and by reducing the first amount of time by the difference.

In a variation on this embodiment, the system can receive time-measuring rules which specify when to start measuring time and when to stop measuring time for applications. The system can then measure time spent on applications in accordance with the time-measuring rules.

In a variation on this embodiment, the system can use the time spent data to generate bills. Specifically, the system can receive billing rules which specify how to associate a time spent record with a client and a matter. Next, the system can receive a request to generate a bill for a client. The system can then determine billable time for the client using the time spent data and the billing rules. Next, the system can generate the bill using the billable time.

### BRIEF DESCRIPTION OF THE FIGURES

FIG. 1 illustrates how a user can use applications in accordance with an embodiment of the present invention.

FIG. 2 presents a flowchart that illustrates a process for visually indicating time spent on applications in accordance with an embodiment of the present invention.

FIG. 3 illustrates how a visual indicator can convey the amount of time spent on an application in a non-textual manner in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Applications

An application can generally be any system which is used to perform a task. Specifically, applications can include software, hardware, and/or URLs (uniform resource locators). For example, an email application can be a piece of software which is used for sending, receiving, viewing, and/or composing emails. Alternatively, an email application can be a URL which enables a user to use a web browser to perform email related tasks. An email application can also be a hardware device which can perform email related tasks. In other words, an application can generally be any computer-based technology or device which enables a user to perform a task.

There are a number of tasks that can be performed using applications. For example, documents can be created using word processing applications, spreadsheets can be created using spreadsheet applications, tax returns can be prepared using tax preparation applications, and phone calls can be made using phone applications. Note that these tasks and applications have been presented for illustration purposes, and are not intended to limit the present invention. Specifically, an application can include any technology now known or later developed which is used for performing tasks.

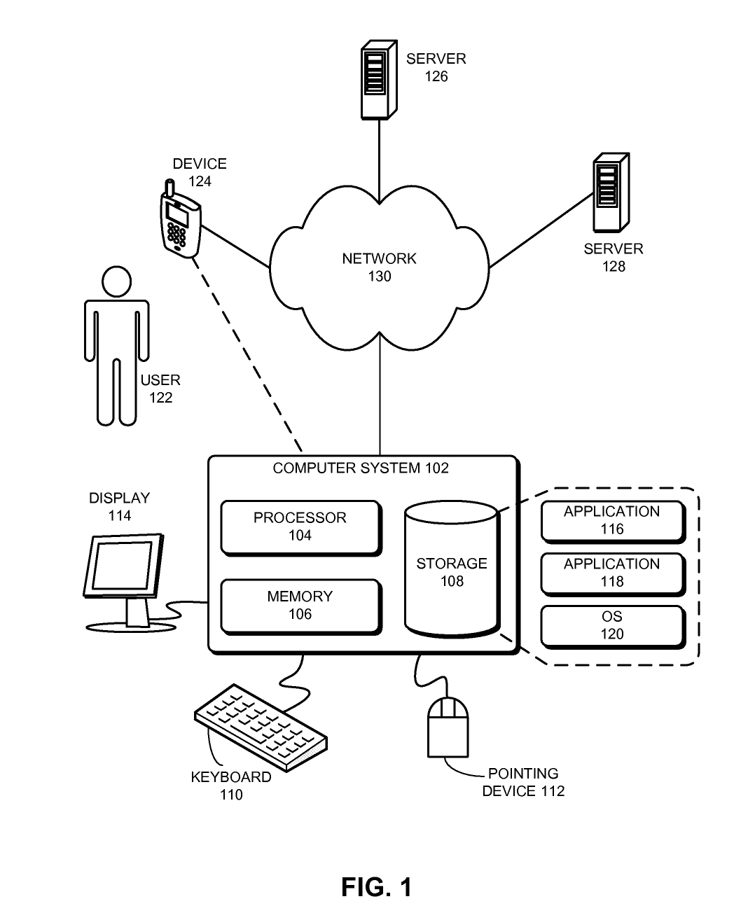

FIG. 1 illustrates how a user can use applications in accordance with an embodiment of the present invention.

Computer 102 comprises processor 104, memory 106, and storage device 108. Computer 102 can be coupled with display 114, keyboard 110, and pointing device 112. Storage device 108 can store applications 116 and 118, and operating system 120. During operation, computer 102 can load operating system 120 into memory 106. Next, user 122 can load application 116 into memory 106 and use it to perform a task, e.g., edit a document.

Computer 102 can be coupled with network 130 which can enable computer 102 to communicate with servers 126 and 128. Network 130 can generally comprise any type of wire or wireless communication channel capable of coupling together network nodes. This includes, but is not limited to, a local area network, a wide area network, or a combination of networks, or other network enabling communication between two or more computing systems. In one embodiment of the present invention, network 130 comprises the Internet.

User 122 may use a web browser to communicate with server 126 which may support an online application. Device 124 may be used to perform one or more tasks. For example, device 124 may be used for sending and receiving emails, for making phone calls, and/or for web-browsing. Device 124 may be coupled with network 130 via a wire or wireless communication channel. For example, device 124 may be coupled with network 130 via a Wi-Fi channel (shown using a solid line). In addition, device 124 may also be coupled directly with computer 102 via a wire or wireless communication channel (shown using a dotted line). For example, device 124 may be coupled with computer 102 via USB (Universal Serial Bus) and/or Bluetooth.

An application can be considered to be active when the application's status most likely indicates that the user is using the application to perform a task. For example, when a user is typing an email, the email application may be considered to be active. Similarly, when a user is talking on the phone, the phone application can be considered to be active. If a user multitasks, it is possible for multiple applications to be “active” at the same time. For example, while using a word processor to create a document, the user might be talking on the phone. In such situations, the system may conclude that both the editor and the phone are active at the same time.

If the system detects that multiple applications are active at the same time, the system may record the time spent on the multiple applications. For example, if a user was simultaneously using a first application and a second application between 1:00 PM and 2:00 PM, the time spent data may indicate that the user spent one hour on a first application and one hour on a second application. The system can subsequently reconcile the time spent data based on user-specified rules.

### Process for Visually Indicating Time Spent on an Application

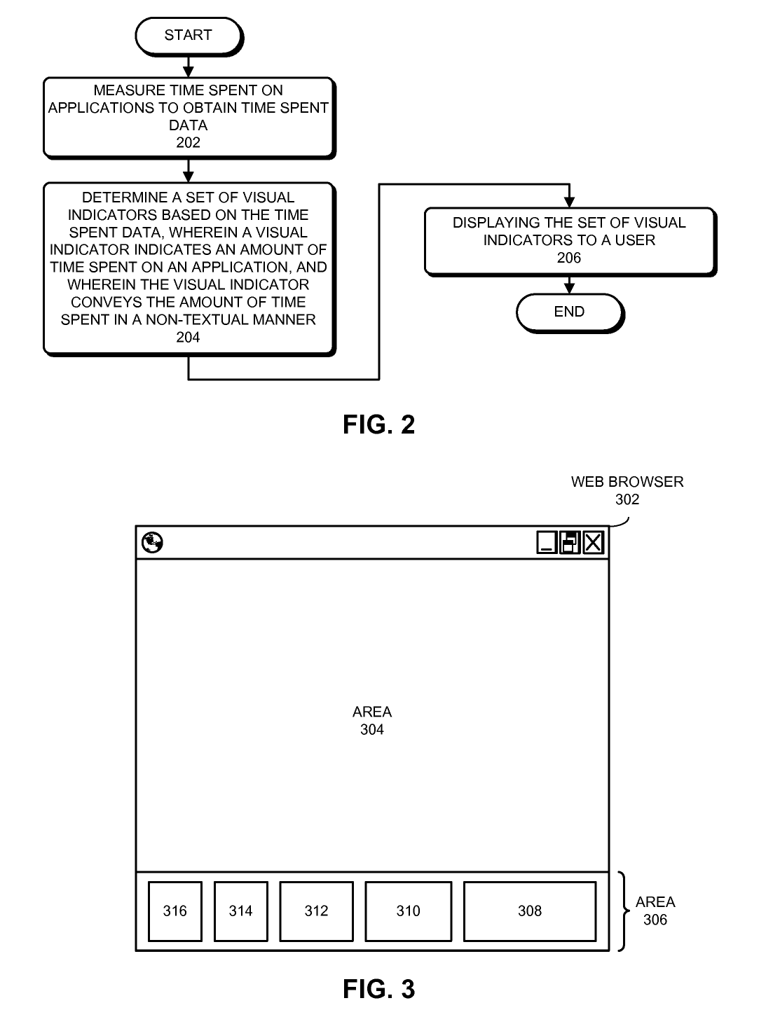

FIG. 2 presents a flowchart that illustrates a process for visually indicating time spent on applications in accordance with an embodiment of the present invention.

During operation, the system may measure time spent on applications to obtain time spent data (step 202). The user may specify which applications to monitor. For example, the user may not want the system to measure time when the user visits a secure or private website. In one embodiment, the user can provide a list of applications which the user does not want the system to monitor and the user may also manually turn off monitoring for an application during operation. Specifically, the system can receive a request from a user to stop measuring time spent for an application. In response, the system can stop measuring time for the application, but continue measuring time spent on other applications. The user may also specify days of the week and/or times during the day when the system should monitor applications to obtain time spent data.

The system can measure the time spent on an application using a number of techniques. For example, the system can use a web-browser plug-in to keep track of time spent on websites during web-browsing. The time-monitoring module may aggregate all the time that is spent on a website into a single quantity, or it may create a separate time spent record for each visit to the website.

The system can enable the user to specify time-measuring rules which specify when to start measuring time and when to stop measuring time for applications. For example, the user may specify that the time spent data should only be recorded if the user spends at least a minimum amount of time on the application, thereby preventing the system from measuring time for applications or websites that the user may have mistakenly used. The time-measuring rules can be different for different applications. For example, the time-measuring rule for a web-browser may specify that the system should start recording time spent data only if the user spends at least ten seconds on a website, but the time-measuring rule for a word processor may specify that the system should start recording time spent data as soon the user opens a document for editing purposes.

In one embodiment, the system uses an operating system service to detect which application is active at any given time. For example, whenever the active window on the desktop changes, the operating system can alert the software module that is recording time spent data. The system may also determine if an application is active by keeping track of whether the user is actively interacting with an application using a keyboard, mouse, or some other input device. The system may also employ idle timers to determine when to stop recording time spent. For example, the system may start measuring time for an application as soon as the application's window is selected. However, if the user remains idle for a specified amount of time, the system may stop measuring the time spent on the application. In one embodiment, the system can reduce the recorded time spent by estimating when the computer became idle. An idle timeout might be 10 minutes, indicating the user stopped using the computer 10 minutes ago. The system could reduce the calculated time spent on an application by the idle timeout.

If the time spent data indicates that the user spent time on two applications at the same time, the system may reconcile the data using a number of techniques. In one embodiment, the time spent data may indicate that a first amount of time was spent on a first application at the same time as a second amount of time was spent on a second application. The system may reconcile such time spent records by determining a difference between the first amount of time and the second amount of time, and by reducing the first amount of time by the difference. For example, if the time spent data shows that the user simultaneously spent time on an email application and on a phone application, the system may subtract the time spent on the phone application from the time spent on the email application to avoid double counting. Alternatively, the system may ignore the time spent on the phone application.

The reconciliation process can be based on user-specified rules. For example, the user may specify that if the time spent data shows that a web browser application and a word processor application were active at the same time, the system should ignore the time spent on the web browser since the user was most probably searching for information on the web while drafting the document.

Continuing with the flowchart shown in FIG. 2, the system may determine a set of visual indicators based on the time spent data, wherein a visual indicator indicates an amount of time spent on an application, and wherein the visual indicator conveys the amount of time spent in a non-textual manner (step 204).

The system can then display the set of visual indicators to a user (step 206).

Although the system can use different types of visual indicators, it is important to ensure that the visual indicators are of a highly intuitive nature so that the user can quickly glance at the visual indicators and immediately understand how much time the user spent on the applications.

Indicators that convey information using text may not be sufficiently intuitive because they require the user to read the text, and then to mentally process the textual information to understand how much time was spent on the applications. Further, conveying information using text can cause information overload if the user is shown a large number of items which convey textual information. In contrast to text-based indicators, visual indicators that convey information in a non-textual manner can immediately tell the user how much time was spent on the different applications. For example, the system may indicate the time spent by using the size and/or location of the visual indicator.

FIG. 3 illustrates how a visual indicator can convey the amount of time spent on an application in a non-textual manner in accordance with an embodiment of the present invention.

Web-browser 302 can include area 304 which is used for displaying a website, and area 306 which is used for displaying visual indicators to indicate the amount of time spent on different applications or websites. Area 306 can include visual indicators 308, 310, 312, 314, and 316.

In one embodiment, the size and/or the location of the visual indicator is used to indicate the amount of time spent on a website. For example, since visual indicator 308 is larger than visual indicator 316, it may indicate that the user spent more time on the website or application associated with visual indicator 308 than on the website or application associated with visual indicator 316. Note that using the visual indicator's size to convey information about how much time was spent on a website or application enables the user to quickly glance at area 304 and immediately understand the applications and websites on which user spent the maximum or minimum amounts of time.

The visual indicators can be organized in a number of ways. For example, the visual indicators can be organized so that the time spent increases from the left to the right. Alternatively, visual indicators can be arranged based on when the user visited the website or used the application, e.g., the rightmost indicator can be the most recent website or application, and the leftmost indicator can be the oldest website or application.

The system doesn't necessarily have to keep track of all websites that a user visits. For example, if a user spends less than a certain amount of time on a website, the system may either ignore the website or add the time spent on the website to a “dominant” application which is concurrently active. Specifically, a user may perform a web search to find some information and use the information to draft an email for a client. In this scenario, the time spent on the web-search application can be added to the time spent on the email application which was used for drafting the email. Further, the system may decide to ignore the time spent on a website or an application based on user-specified rules.

A visual indicator may include a snapshot of the associated application (e.g., a website) thereby enabling a user to quickly identify the application. Using a snapshot of a website (which is a non-textual indicator) instead of simply displaying the website's URL may help the user to quickly identify the website associated with the visual indicator.

The system can use other types of visual indicators that convey time spent information in a non-textual fashion. For example, the system can use a pie symbol to indicate the amount of time spent on an application. If the pie symbol is substantially full, it can indicate that the user spent a large amount of time on the application, whereas if the pie symbol is substantially empty, it can indicate that the user spent a small amount of time on the application.

In yet another embodiment, the system can use colors to indicate the amount of time spent. For example, the system can display a red colored border around the application's snapshot to indicate that the user spent substantially large amount of time on the application, a yellow border to indicate that the user spent an average amount of time on the application, and a green border to indicate that the user spent a small amount of time on the application. The system can also enable the user to search the time spent data so that the user can quickly determine when the user used the application and how much time the user spent on the application.

These embodiments have been presented for illustration purposes, and are not intended to limit the present invention to the forms disclosed. Accordingly, many modifications and variations will be apparent to practitioners skilled in the art. For example, the system may reserve an area on the desktop screen to display visual indicators which indicate the time spent on applications. Alternatively, the visual indicators may not be displayed to the user until the user specifically requests them to be shown, e.g., by clicking on an icon.

The system may use different techniques to measure the time spent. For example, the system may determine the time spent on a phone application based on phone logs it receives from the telephone company. For example, in FIG. 1, when user 122 uses device 124 to make a phone call, the telephone company may record the duration of the phone call and store the information on server 128. Subsequently, application 118 may retrieve the phone call logs from server 128 to determine the amount of time spent on the phone application. Alternatively, device 124 may itself keep track of time spent, and it may send the time spent data to computer 102 via a local wire or wireless communication link.

In addition to helping the user keep track of how the user is spending his or her time, the time spent data can also be used for generating bills. Specifically, the system can associate client and matter information with each time spent record. Next, the system can generate a bill for a client by collecting all time spent records for one or more client matters.

The user can specify billing rules which specify how to associate a time spent record with a client matter. For example, the user may specify that for word processing applications, the location of the document determines the client, and the file name determines the client matter. On the other hand, for a phone application, the user may specify that the called phone number is to be used to determine the client and the client matter. Alternatively, the user may specify that the client and/or client matter is to be derived based on a calendar entry if the phone is a scheduled conference call. In yet another scenario, the user may specify that if the phone call is made while the user is working on a particular client matter, the time spent data for the phone application should be associated with that particular client matter.

In one embodiment, the system may receive a request to generate a bill for a client. Next, the system may determine billable time for the client using the time spent data and the billing rules. The system can then generate the bill using the billable time. When a user generates a bill for a client for a particular client matter, the system may list all the time associated with that particular client matter and enable the user to adjust the time as appropriate.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for visually indicating time spent on applications, the method comprising:
measuring time spent on applications to obtain time spent data;
generating visual indicators based on the time spent data, wherein a visual indicator indicates an amount of time spent on an application, and wherein the visual indicator conveys information in a non-textual manner; and
displaying the visual indicators to a user.

2. The method of claim 1, wherein the applications include one of:
an e-mail application;
a word processing application;
a spreadsheet application;
a tax preparation application;
a phone application;
a web-browser application; and
a website which provides a web-based application.

3. The method of claim 1, further comprising:
receiving a request from a user to stop measuring time spent for a first application; and
measuring time spent on applications other than the first application.

4. The method of claim 1, wherein the time spent data indicates that a first amount of time was spent on a first application at the same time as a second amount of time was spent on a second application, wherein the method further comprises:
determining a difference between the first amount of time and the second amount of time; and
reducing the first amount of time by the difference.

5. The method of claim 1, wherein prior to measuring time spent on applications, the method further comprises receiving time-measuring rules which specify when to start measuring time and when to stop measuring time for applications.

6. The method of claim 1, further comprising:
receiving billing rules which specify how to associate a time spent record with a client and a matter;
receiving a request to generate a bill for a client;
determining billable time for the client using the time spent data and the billing rules; and
generating the bill using the billable time.

7. The method of claim 1, wherein the visual indicator's size is used to convey the amount of time spent.

8. The method of claim 1, wherein the visual indicator's location is used to convey the amount of time spent.

9. The method of claim 1, wherein the visual indicator's color is used to convey the amount of time spent.

10. The method of claim 1, wherein the visual indicator includes a snapshot of the application to enable the user to quickly identify the application associated with the visual indicator.

11. A computer-readable storage medium storing instructions that when executed by a computer cause the computer to perform a method for visually indicating time spent on applications, the method comprising:
measuring time spent on applications to obtain time spent data;
generating visual indicators based on the time spent data, wherein a visual indicator indicates an amount of time spent on an application, and wherein the visual indicator conveys information in a non-textual manner; and
displaying the visual indicators to a user.

12. The computer-readable storage medium of claim 11, wherein the applications include one of:
an e-mail application;
a word processing application;
a spreadsheet application;
a tax preparation application;
a phone application;
a web-browser application; and
a website which provides a web-based application.

13. The computer-readable storage medium of claim 11, wherein the method further comprises:
receiving a request from a user to stop measuring time spent for a first application; and
measuring time spent on applications other than the first application.

14. The computer-readable storage medium of claim 11, wherein the time spent data indicates that a first amount of time was spent on a first application at the same time as a second amount of time was spent on a second application, wherein the method further comprises:
determining a difference between the first amount of time and the second amount of time; and
reducing the first amount of time by the difference.

15. The computer-readable storage medium of claim 11, wherein prior to measuring time spent on applications, the method further comprises receiving time-measuring rules which specify when to start measuring time and when to stop measuring time for applications.

16. The computer-readable storage medium of claim 11, wherein the method further comprises:
receiving billing rules which specify how to associate a time spent record with a client and a matter;
receiving a request to generate a bill for a client;
determining billable time for the client using the time spent data and the billing rules; and
generating the bill using the billable time.

17. The computer-readable storage medium of claim 11 wherein the visual indicator's size is used to convey the amount of time spent.

18. The method of claim 11, wherein the visual indicator's location is used to convey the amount of time spent.

19. The computer-readable storage medium of claim 11, wherein the visual indicator's color is used to convey the amount of time spent.

20. The computer-readable storage medium of claim 11, wherein the visual indicator includes a snapshot of the application to enable the user to quickly identify the application associated with the visual indicator.

21. An apparatus for visually indicating time spent on applications, the apparatus comprising:
a measuring mechanism configured to measure time spent on applications to obtain time spent data;
a generating mechanism configured to generate visual indicators based on the time spent data, wherein a visual indicator indicates an amount of time spent on an application, and wherein the visual indicator conveys information in a non-textual manner; and
a displaying mechanism configured to display the visual indicators to a user.

22. The apparatus of claim 21, wherein the visual indicator's size is used to convey the amount of time spent, and wherein the visual indicator includes a snapshot of the application to enable the user to quickly identify the application associated with the visual indicator.
